(19) United States
(12) Patent Application Publication
(10) Pub. No.: US 2011/0001739 A1
(43) Pub. Date: Jan. 6, 2011

(54) DISPLAY APPARATUS AND METHOD OF TESTING THE SAME

(75) Inventor: Nobuhisa YAMAGISHI, Kanagawa (JP)

Correspondence Address: YOUNG & THOMPSON, 209 Madison Street, Suite 500, Alexandria, VA, 22314, US

(73) Assignee: NEC ELECTRONICS CORPORATION, Kanagawa (JP)

(21) Appl. No.: 12/783,879

(22) Filed: May 20, 2010

(30) Foreign Application Priority Data
Jul. 6, 2009 (JP) 2009-159619

(51) Int. Cl. G06F 3/038

(52) U.S. Cl. 345/208

(57) ABSTRACT

A display apparatus includes a delay generation circuit that generates a reference signal and a competing signal, the competing signal being generated based on a delay set signal, an input order judgment circuit that judges an input order of the reference signal and the competing signal, a delay set circuit that generates the delay set signal based on a judgment result in the input order judgment circuit, and an internal synchronous control circuit that controls transfer of display data between a CPU and a display panel. An operation test of the internal synchronous control circuit is performed using the reference signal and the competing signal. Hence, fault coverage can be enhanced.

### INCORPORATION BY REFERENCE

This application is based upon and claims the benefit of priority from Japanese patent application No. 2009-159619, filed on Jul. 6, 2009, the disclosure of which is incorporated herein in its entirety by reference.

### BACKGROUND

1. Field of the Invention

The present invention relates to a display apparatus and a method of testing the same, and more specifically, to a display apparatus including a circuit that tests an internal synchronous control circuit and a method of testing the same.

2. Description of Related Art

In recent years, a transferred data amount in a display apparatus is increased because of the increase in an image size or improvement of image quality, and an operation speed of a display apparatus is increased to deal with video display. Thus, a load in a control apparatus (hereinafter also referred to as CPU) has been increased.

FIG. 7 is a block diagram showing a display apparatus using a display control semiconductor integrated circuit disclosed in Japanese Unexamined Patent Application Publication No. 2003-288202. As shown in FIG. 7, a display control semiconductor integrated circuit 101 is used for controlling transfer of display data between a CPU 102 and a display panel 103 of a display apparatus. The display control semiconductor integrated circuit 101 executes transfer control of display data through a built-in single-port RAM 104 while synchronizing write/read and display read using an internal synchronous control circuit 105 included in the circuit 101.

FIG. 8 is a circuit diagram showing an internal synchronous control circuit included in the display control semiconductor integrated circuit shown in FIG. 7. The internal synchronous control circuit shown in FIG. 8 includes a control unit 110, a display read signal generation circuit 130, a judgment flag signal generation circuit 140, and two OR circuits 150(1) and 150(2). The control unit 110 includes a reset signal input end RES, write/read signal input ends WE bar/RE bar, a display read signal input end DRE bar, a judgment flag signal input end FLAG, an enable signal output end EN, display read signal output ends LAC bar, a LAC1 bar, and a LAC2 bar. The display read signal generation circuit 130 includes a reset signal input end RES, display read signal input ends LAC1 bar and LAC2 bar, a display read signal output end LBE, and a trigger signal output end TRIG. The judgment flag signal generation circuit 140 includes a reset signal input end RES, a display read signal input end LBE, a trigger signal input end TRIG, and a judgment flag signal output end FLAG.

In the internal synchronous control circuit shown in FIG. 8, a reset signal RES is supplied to one input of the OR circuit 150(1). Further, write/read signals WE bar/RE bar are supplied to the write/read signal input ends WE bar/RE bar of the control unit 110 and to write/read signal output ends WE bar/RE bar of the internal synchronous control circuit 105. A display read signal DRE bar is supplied to the display read signal input end DRE bar of the control unit 110 and to the other input of the OR circuit 150(1). An output of the OR circuit 150(1) is supplied to the respective reset signal input ends RES of the control unit 110 and the judgment flag signal generation circuit 140, and is also supplied to one input of the OR circuit 150(2). An output of the OR circuit 150(2) is supplied to the reset signal input end RES of the display read signal generation circuit 130.

Output signals from the control unit 110 are supplied to other input circuits as follows. The enable signal EN is supplied to the other input of the OR circuit 150(2). The display read signals LAC1 bar and LAC2 bar are supplied to the display read signal input ends LAC1 bar and LAC2 bar of the display read signal generation circuit 130, respectively. The display read signal LAC bar is supplied to a display read signal output end LAC bar of the internal synchronous control circuit 105.

Output signals from the display read signal generation circuit 130 are supplied to other input circuits as follows. The display read signal LBE is supplied to a display read signal output end LBE of the internal synchronous control circuit 105 and to the display read signal input end LBE of the judgment flag signal generation circuit 140. The trigger signal TRIG is supplied to the trigger signal input end TRIG of the judgment flag signal generation circuit 140. A judgment flag signal FLAG, which is an output signal from the judgment flag signal generation circuit 140, is supplied to the judgment flag signal input end FLAG of the control unit 110.

The control unit 110 includes, as shown in FIG. 9, three AND circuits 111(1) to 111(3), five OR circuits 112(1) to 112(5), 10 NOT circuits 113(1) to 113(10), three D flip-flops 114(1) to 114(3), one first delay circuit 115, one second delay circuit 116, two third delay circuits 117(1) and 117(2), and one switch circuit 118.

The AND circuit 111(1), the NOT circuit 113(1), and the second delay circuit 116 constitute a first shot circuit 119. The AND circuit 111(1) has one input directly connected to the display read signal DRE bar, and the other input connected to the display read signal DRE bar through the NOT circuit 113(1) and the second delay circuit 116. The first shot circuit 119 thus outputs a positive one-shot pulse at a rising edge of the input.

The OR circuits 112(1) and 112(2), the NOT circuits 113(2) and 113(3), and the third delay circuits 117(1) and 117(2) constitute second shot circuits 120(1) and 120(2). A signal input to one end of the OR circuit 112(1) is also input to the other end of the OR circuit 112(1) through the NOT circuit 113(2) and the delay circuit 117(1). A signal input to one end of the OR circuit 112(2) is also input to the other end of the OR circuit 112(2) through the NOT circuit 113(3) and the third delay circuit 117(2). Each of the second shot circuits 120(1) and 120(2) thus outputs a negative one-shot pulse at a rising edge of the input.

In each input end of the control unit 110, the write/read signal input ends WE bar/RE bar are connected to two inputs of the AND circuit 111(2), the judgment flag signal input end FLAG is connected to a data input D of the D flip-flop 114(1), the reset signal input end RES is connected to a reset input R of the D flip-flop 114(1), the display read signal input end DRE bar is connected to a reset input R of the D flip-flop 114(2), the input of the first delay circuit 115, and an input of the first shot circuit 119.

An output of the AND circuit 111(2) is connected to clock inputs of the D flip-flop 114(1) and the D flip-flop 114(2), the data input D of the D flip-flop 114(3) through the NOT circuit 113(4), and one input of each of the OR circuits 112(3), 112(4), and 112(5) and the enable signal output end EN through the NOT circuit 113(5).

An output Q of the D flip-flop 114(1) is connected to an input of the second shot circuit 120(2) through the NOT circuit 113(6). An output Q of the D flip-flop 114(2) is connected to an input IN2 of the switch circuit 118 through the NOT circuit 113(7). An output of the first delay circuit 115 is connected to a clock input of the D flip-flop 114(3) and a data input D of the D flip-flop 114(2) through the NOT circuit 113(8), and to an input IN1 of the switch circuit 118 through the NOT circuit 113(9).

An output of the first shot circuit 119 is connected to a reset input R of the D flip-flop 114(3). An output Q of the D flip-flop 114(3) is connected to an input SEL of the switch circuit 118. An output of the switch circuit 118 is connected to an input of the second shot circuit 120(1) through the NOT circuit 113(10). Outputs of the second shot circuits 120(1) and 120(2) are connected to two inputs of the AND circuit 111(3) and the other inputs of the OR circuits 112(3) and 112(4). An output of the AND circuit 111(3) is connected to the other input of the OR circuit 112(5). Outputs of the OR circuits 112(3), 112(4), and 112(5) are connected to the display read signal output ends LAC1 bar, LAC2 bar, and LAC bar, respectively.

The output signal EN is generated as the signal to recognize presence or absence of the write/read command from the inputs of the write/read signals WE bar/RE bar transferred from the CPU 102, and functions as each output enable of the LAC bar, the LAC1 bar, and the LAC2 bar that will be described later. The output signal LAC1 bar is generated as the display read signal to output the display read command when the write/read and the display read are non-competing. The output signal LAC2 bar is generated as the display read signal to output a redisplay read command when the write/read and the display read are competing, and feeds back the judgment flag signal FLAG. The output signal LAC bar is generated as the display read signal to recognize the write/read cancel from the CPU 102 by the output signals LAC1 bar and the LAC2 bar. Further, the input signal RES has a system reset function.

The display read signal generation circuit 130 includes, as shown in FIG. 10, two AND circuits 131(1) and 131(2), four OR circuits 132(1) to 132(4), six NOT circuits 133(1) to 133(6), two D flip-flops 134(1) and 134(2), two fourth delay circuits 135(1) and 135(2), two fifth delay circuits 136(1) and 136(2), and two sixth delay circuits 137(1) and 137(2).

The OR circuits 132(1) and 132(2), the NOT circuits 133(3) and 133(4), and the fifth delay circuits 136(1) and 136(2) constitute third shot circuits 138(1) and 138(2). The OR circuit 132(1) has one input directly connected to the delay circuit 135(1) and the other input connected to the delay circuit 135(1) through the NOT circuit 133(3) and the delay circuit 136(1). The OR circuit 132(2) has one input directly connected to the delay circuit 135(2) and the other input connected to the delay circuit 135(2) through the NOT circuit 133(4) and the delay circuit 136(2). Each of the third shot circuits 138(1) and 138(2) outputs a negative one-shot pulse at a rising edge of the input.

Further, the AND circuits 131(1) and 131(2), the NOT circuits 133(5) and 133(6), and the sixth delay circuits 137(1) and 137(2) constitute fourth shot circuits 139(1) and 139(2). A signal input to one end of the AND circuit 131(1) is also input to the other end of the AND circuit 131(1) through the NOT circuit 133(5) and the delay circuit 137(1). A signal input to one end of the AND circuit 131(2) is also input to the other end of the AND circuit 131(2) through the NOT circuit 133(6) and the delay circuit 137(2). Each of the fourth shot circuits 139(1) and 139(2) outputs a positive one-shot pulse at a rising edge of the input.

The reset signal input end RES of the display read signal generation circuit 130 is connected to respective reset inputs R of the D flip-flops 134(1) and 134(2). The display read signal input ends LAC1 bar and LAC2 bar are connected to respective data inputs D of the D flip-flops 134(1) and 134(2) through the NOT circuits 133(1) and 133(2), respectively, and are connected to clock inputs C of the D flip-flops 134(1) and 134(2) through the fourth delay circuits 135(1) and 135(2) and the third shot circuits 138(1) and 138(2). Outputs Q of the D flip-flops 134(1) and 134(2) are connected to two inputs of the OR circuit 132(3) through the fourth shot circuits 139(1) and 139(2), and an output of the OR circuit 132(3) is connected to the display read signal output end LBE. Further, the other inputs of the OR circuits 132(1) and 132(2) are connected to two inputs of the OR circuit 132(4), and an output of the OR circuit 132(4) is connected to the trigger signal output end TRIG.

The output signal LBE is a display read signal generated based on the input signals LAC1 bar and the LAC2 bar output from the control unit 110. The output signal LBE is a display read command having a timing and a pulse width required for judging the competing state and the non-competing state. The necessary timing is adjusted in the fourth delay circuits 135(1) and 135(2), and the necessary pulse width is adjusted in the sixth delay circuits 137(1) and 137(2). Further, the output signal TRIG is generated as the trigger signal to judge if there is a pulse width that is sufficient to read out display data from the RAM 104 by the display read signal LBE. The input signal RES has a system reset function.

The judgment flag signal generation circuit 140 includes, as shown in FIG. 11, three NOT circuits 141(1) to 141(3), one D flip-flop 142, and one seventh delay circuit 143. The reset signal input end RES of the judgment flag signal generation circuit 140 is connected to a reset input R of the D flip-flop 142, the display read signal input end LBE is connected to a data input D of the D flip-flop 142 through the NOT circuit 141(1), the trigger signal input end TRIG is connected to a clock input C of the D flip-flop 142 through the NOT circuits 141(2), 141(3) and the seventh delay circuit 143. An output Q of the D flip-flop 142 is connected to the judgment flag signal output end FLAG.

The output flag FLAG compares the pulse width of the display read signal LBE with the delay time of the seventh delay circuit 143 with respect to time using the display read signal LBE and the trigger signal TRIG output from the display read signal generation circuit 130 to judge whether the “HIGH” pulse width of the display read signal LBE has a time required to read out data from the RAM 104. When the pulse width of the display read signal LBE is shorter than the delay time of the seventh delay circuit 143, the signal level is set to “HIGH” level. Then, the judgment flag signal is generated to transfer display data reading error judgment from the RAM 104 to the control unit 110. The input signal RES includes a system reset function.

In non-competing as shown in FIG. 12A, there is no competing with the display read command from time t1 to t2 where the write signal is “HIGH”. The display read signal is “HIGH” in a period of time t2 where there is no competing with the write command to time t3 where the next write signal is raised to “HIGH”. Thus, the display data is directly read out from the RAM 104 in this period.

In FIG. 12B, there is competing with the display read command because the display read signal is raised to “HIGH” at a period from time t1 to t2 where the write signal is “HIGH”. Then, “HIGH” level period of the display read signal is delayed at a period from time t2 where there is no competing with the write command to time t3 where the next write signal is raised to “HIGH”. The display data is read out from the RAM 104.

In FIG. 12C, after the display read signal is raised to “HIGH”, the write signal is raised to “HIGH” at time t1 in the middle of display reading. Then, the competing with the write command is detected. At this time, the display reading is suspended, and judgment is made whether the display reading is completed. When the display reading is not completed, the judgment flag is raised. At time t2 where there is no more competing with the write command, the display read signal is raised to “HIGH” again, and the display data is read out from the RAM 104.

As stated above, in the display control semiconductor integrated circuit disclosed in Japanese Unexamined Patent Application Publication No. 2003-288202, the write/read commands from the CPU are always given precedence over the display read commands, so as to mitigate the load of the control system in the CPU side.

### SUMMARY

The present inventors have found a problem as follows in the display control semiconductor integrated circuit according to Japanese Unexamined Patent Application Publication No. 2003-288202. That is, as there is no measure to externally observe the competing state of the display read command and the write/read command, it is impossible to check whether there is a competing state in the circuit. Further, the display control semiconductor integrated circuit disclosed in Japanese Unexamined Patent Application Publication No. 2003-288202 does not include a circuit to generate the competing state as desired. The internal synchronous control circuit is tested while stochastically predicting the competing state. Thus, there is great variability in the fault coverage, which degrades the test reliability.

A first exemplary aspect of the invention is a display apparatus including a delay generation circuit that generates a reference signal and a competing signal, the competing signal being generated based on a delay set signal, an input order judgment circuit that judges an input order of the reference signal and the competing signal, a delay set circuit that generates the delay set signal based on a judgment result in the input order judgment circuit, and an internal synchronous control circuit that controls transfer of display data between a CPU and a display panel, in which an operation test of the internal synchronous control circuit is performed using the reference signal and the competing signal.

According to the display apparatus of the present invention, the competing state of the reference signal and the competing signal is generated using the delay generation circuit, the input order judgment circuit, and the delay set circuit, and the operation test of the internal synchronous control circuit is executed using these signals. Hence, the fault coverage can be enhanced.

A second exemplary aspect of the invention is an operation test method of a display apparatus including an internal synchronous control circuit, the circuit controlling transfer of display data between a CPU and a display panel, the operation test method including generating a reference signal and a competing signal, judging an input order of the reference signal and the competing signal, generating the delay set signal based on judgment result of the input order, generating the competing signal based on the delay set signal, and executing an operation test of the internal synchronous control circuit using the reference signal and the competing signal.

According to the operation test method of the display apparatus of the present invention, the competing state of the reference signal and the competing signal is generated, and the operation test of the internal synchronous control circuit is executed using these signals. Hence, the fault coverage can be enhanced.

According to the present invention, it is possible to provide the display apparatus and the test method of the display apparatus capable of enhancing the fault coverage.

### BRIEF DESCRIPTION OF THE DRAWINGS

The above and other exemplary aspects, advantages and features will be more apparent from the following description of certain exemplary embodiments taken in conjunction with the accompanying drawings, in which:

FIG. 1 is a circuit diagram showing a competing test circuit of a display apparatus according to a first exemplary embodiment;

FIG. 2 is a circuit diagram showing a delay generation circuit of the competing test circuit according to the first exemplary embodiment;

FIG. 3 is a circuit diagram showing an input order judgment circuit of the competing test circuit according to the first exemplary embodiment;

FIGS. 4A to 4C each shows a timing chart of a test mode signal, a first output signal, and a second output signal of the competing test circuit according to the first exemplary embodiment;

FIG. 5 is a flow chart describing the operation of the competing test circuit of the display apparatus according to the first exemplary embodiment;

FIG. 6 is a flow chart describing the operation of a competing test circuit of a display apparatus according to a second exemplary embodiment;

FIG. 7 is a configuration diagram of a display apparatus disclosed in Japanese Unexamined Patent Application Publication No. 2003-288202;

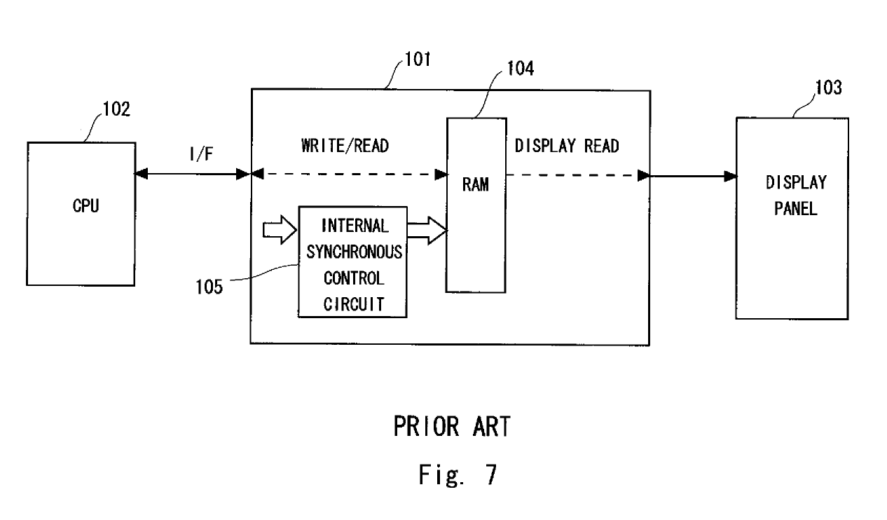

FIG. 8 is a circuit diagram showing an internal synchronous control circuit disclosed in Japanese Unexamined Patent Application Publication No. 2003-288202;

FIG. 9 is a circuit diagram showing a control unit of the internal synchronous control circuit disclosed in Japanese Unexamined Patent Application Publication No. 2003-288202;

FIG. 10 is a circuit diagram showing a display read signal generation circuit of the internal synchronous control circuit disclosed in Japanese Unexamined Patent Application Publication No. 2003-288202;

FIG. 11 is a circuit diagram showing a judgment flag signal generation circuit of the internal synchronous control circuit disclosed in Japanese Unexamined Patent Application Publication No. 2003-288202; and

FIGS. 12A to 12C each shows a timing chart describing a display data transfer control method by a display control semiconductor integrated circuit disclosed in Japanese Unexamined Patent Application Publication No. 2003-288202.

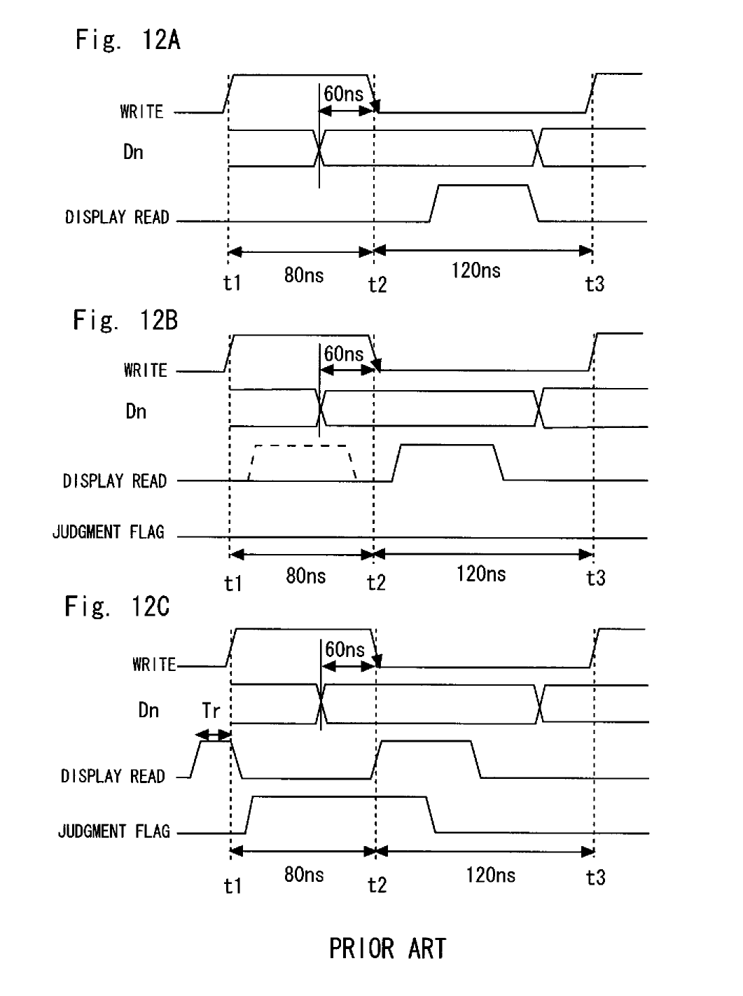

### DETAILED DESCRIPTION OF THE EXEMPLARY EMBODIMENTS

### First Exemplary Embodiment

A first exemplary embodiment of the present invention will be described with reference to the drawings.

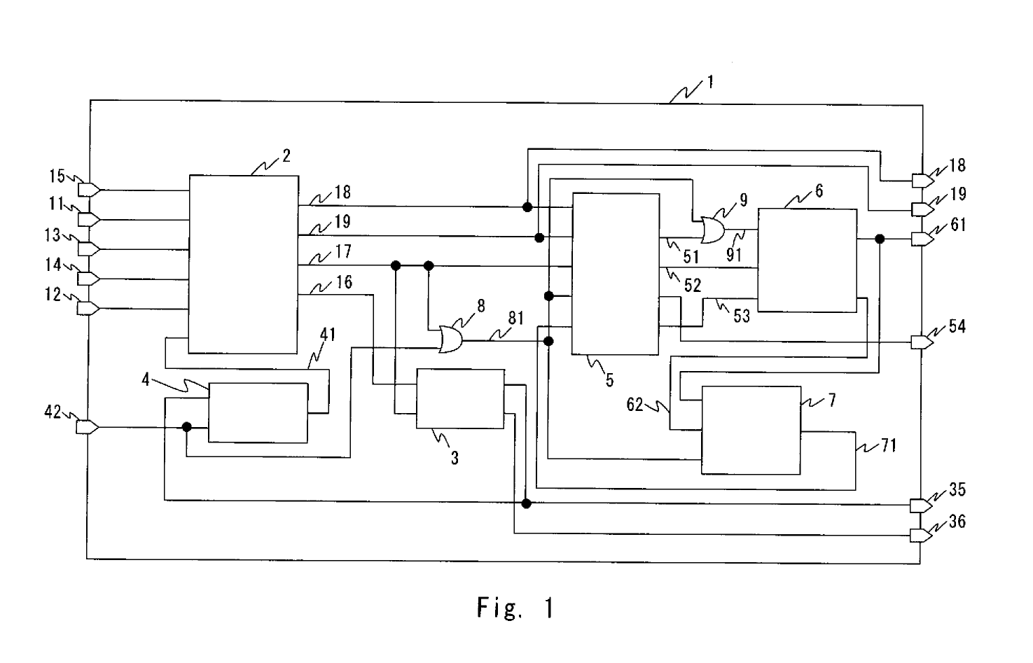

FIG. 1 is a circuit diagram showing a configuration of a competing test circuit of a display apparatus according to the first exemplary embodiment. A competing test circuit 1 includes a delay generation circuit 2, an input order judgment circuit 3, a delay time set circuit 4, a control circuit 5, a display read signal generation circuit 6, a judgment flag signal generation circuit 7, and two OR circuits 8 and 9. Among them, the control circuit 5, the display read signal generation circuit 6, the judgment flag signal generation circuit 7, and the two OR circuits 8 and 9 constitute an internal synchronous control circuit.

The delay generation circuit 2 receives a test mode signal 11, a reference set signal 12, a write/read signal 13, a display read signal 14, a write/read judgment signal 15, and a delay set signal 41 as input signals. Further, the delay generation circuit 2 outputs a first output signal 16, a second output signal 17, a WE bar signal 18, and a RE bar signal 19 as output signals.

The input order judgment circuit 3 receives the first output signal 16 and the second output signal 17 as input signals, and outputs an input order judgment signal 35 and a competing state judgment signal 36 as output signals.

The delay time set circuit 4 receives a RES signal 42 and the input order judgment signal 35 as input signals, and outputs the delay set signal 41 as an output signal.

The control circuit 5 receives the second output signal 17, the WE bar signal 18, the RE bar signal 19, a control circuit RES signal 81, and a FLAG signal 71 as input signals, and outputs a LAC bar signal 54, a LAC1 bar signal 52, a LAC2 bar signal 53, and an EN signal 51 as output signals.

The display read signal generation circuit 6 receives a display read signal generation unit RES signal 91, the LAC1 bar signal 52, and the LAC2 bar signal 53 as input signals, and outputs a LBE signal 61 and a TRIG signal 62 as output signals.

The judgment flag signal generation circuit 7 receives the control circuit RES signal 81, the LBE signal 61, and the TRIG signal 62 as input signals, and outputs the FLAG signal 71 as an output signal.

The test mode signal 11, the reference set signal 12, the write/read signal 13, the display read signal 14, and the write/read judgment signal 15 that are supplied to the competing test circuit 1 are supplied to the delay generation circuit 2. The RES signal 42 supplied to the competing test circuit 1 is input to both of the delay time set circuit 4 and one terminal of the OR circuit 8.

The first output signal 16 which is output from the delay generation circuit 2 is supplied to the input order judgment circuit 3. The second output signal 17 which is output from the delay generation circuit 2 is supplied to the control circuit 5 and the input order judgment circuit 3, and also supplied to the other terminal of the OR circuit 8. The WE bar signal 18 and the RE bar signal 19 that are output from the delay generation circuit 2 are supplied to the control circuit 5 and are also output from the competing test circuit 1.

The LAC bar signal 54 which is output from the control circuit 5 is output from the competing test circuit 1. The LAC1 bar signal 52 and the LAC2 bar signal 53 that are output from the control circuit 5 are supplied to the display read signal generation circuit 6. The EN signal 51 which is output from the control circuit 5 is supplied to one terminal of the OR circuit 9.

The LBE signal 61 which is output from the display read signal generation circuit 6 is supplied to the judgment flag signal generation circuit 7 and is also output from the competing test circuit 1. The TRIG signal 62 which is output from the display read signal generation circuit 6 is supplied to the judgment flag signal generation circuit 7. The FLAG signal 71 which is output from the judgment flag signal generation circuit 7 is supplied to the control circuit 5.

The input order judgment signal 35 which is output from the input order judgment circuit 3 is supplied to the delay time set circuit 4 and is also output from the competing test circuit 1. The competing state judgment signal 36 which is output from the input order judgment circuit 3 is output from the competing test circuit 1.

The delay set signal 41 which is output from the delay time set circuit 4 is supplied to the delay generation circuit 2. The control circuit RES signal 81 which is output from the OR circuit 8 is supplied to the control circuit 5 and the judgment flag signal generation circuit 7, and is also input to the other terminal of the OR circuit 9. The display read signal generation unit RES signal 91 which is output from the OR circuit 9 is supplied to the display read signal generation circuit 6.

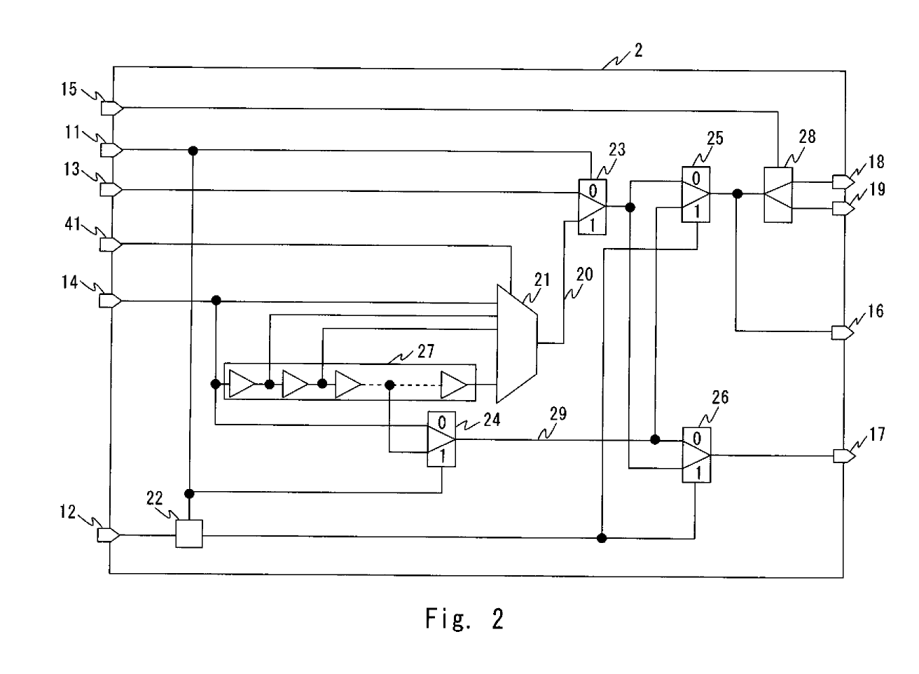

Next, the detail of the delay generation circuit 2 will be described. FIG. 2 shows one example of the delay generation circuit according to the first exemplary embodiment. In FIG. 2, the delay generation circuit 2 includes a multi-input selector 21 that selects one of signals according to the delay set signal 41, two-input selectors 23 and 24 each of which selecting one of signals according to the test mode signal 11, two-input selectors 25 and 26 each of which selecting one of signals according to the reference set signal 12, a two-output selector 28 that selects one of signals according to the write/read judgment signal 15, an enable circuit 22 which is valid when the test mode signal 11 is “1”, and a delay element group 27.

The test mode signal 11 supplied to the delay generation circuit 2 is supplied to the enable circuit 22 and is also supplied to the two-input selectors 23 and 24. The reference set signal 12 supplied to the delay generation circuit 2 is supplied to the enable circuit 22. The write/read signal 13 supplied to the delay generation circuit 2 is supplied to one input of the two-input selector 23. The display read signal 14 supplied to the delay generation circuit 2 is supplied to the multi-input selector 21, one input of the two-input selector 24, and the delay element group 27. The write/read judgment signal 15 supplied to the delay generation circuit 2 is supplied to the two-output selector 28.

The delay set signal 41 supplied to the delay generation circuit 2 is supplied to the multi-input selector 21. Each output of each delay element of the delay element group 27 is supplied to the multi-input selector 21. A competing signal 20, which is an output of the multi-input selector 21, is supplied to the other input of the two-input selector 23. Further, an output (fixed value) of any delay element selected from the delay element group 27 is supplied to the other input of the two-input selector 24. A reference signal 29, which is an output of the two-input selector 24, is supplied to the two-input selectors 25 and 26. An output of the enable circuit 22 is supplied to the two-input selectors 25 and 26.

An output of the two-input selector 23 is supplied to the two-input selectors 25 and 26. An output of the two-input selector 25 is supplied to the two-output selector 28 as the first output signal 16 and is output from the delay generation circuit 2. An output of the two-input selector 26 is output from the delay generation circuit 2 as the second output signal 17. One output of the two-output selector 28 is output from the delay generation circuit 2 as the WE bar signal 18. The other output of the two-output selector 28 is output from the delay generation circuit 2 as the RE bar signal 19.

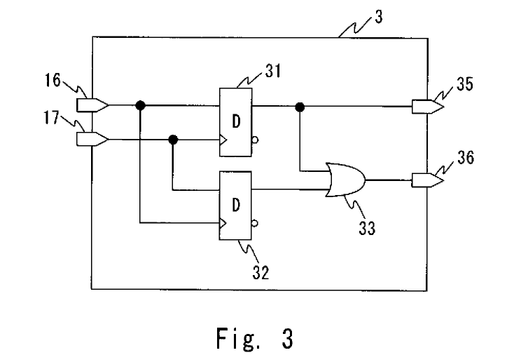

Next, the detail of the input order judgment circuit 3 will be described. FIG. 3 is a circuit diagram showing one example of the input order judgment circuit according to the first exemplary embodiment. In FIG. 3, the input order judgment circuit 3 includes D flip-flops 31, 32 and an OR circuit 33. The first output signal 16 supplied to the input order judgment circuit 3 is supplied to an input of the D flip-flop 31 and to a clock input of the D flip-flop 32. The second output signal 17 supplied to the input order judgment circuit 3 is supplied to an input of the D flip-flop 32 and to a clock input of the D flip-flop 31.

An output of the D flip-flop 31 is supplied to one input of the OR circuit 33 and also is output from the input order judgment circuit 3 as the input order judgment signal 35. An output of the D flip-flop 32 is supplied to the other input of the OR circuit 33. An output of the OR circuit 33 is output from the input order judgment circuit 3 as the competing state judgment signal 36.

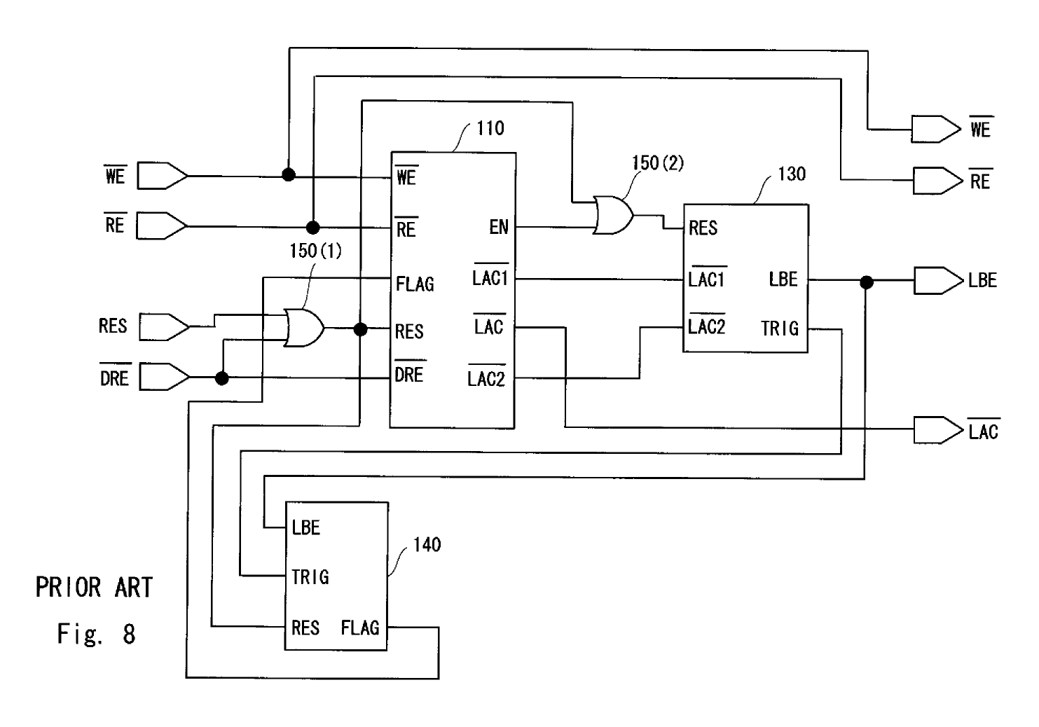

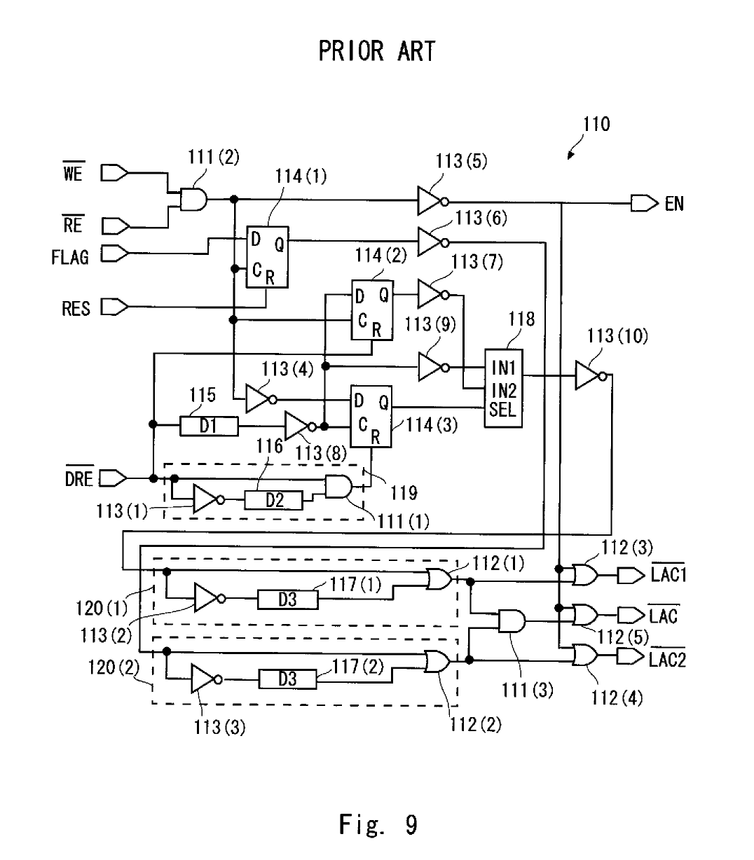

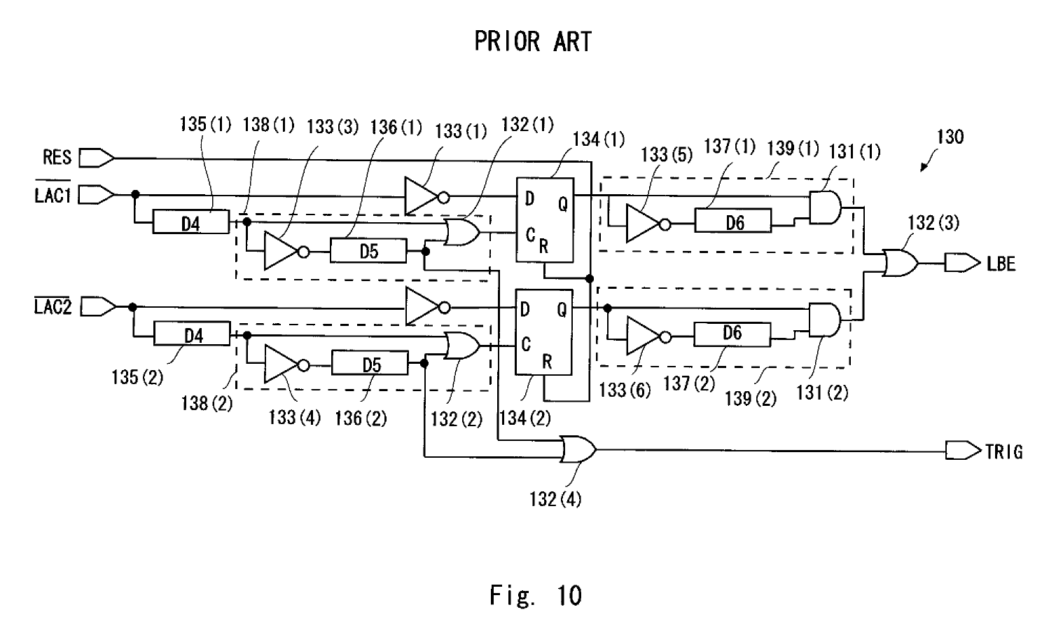

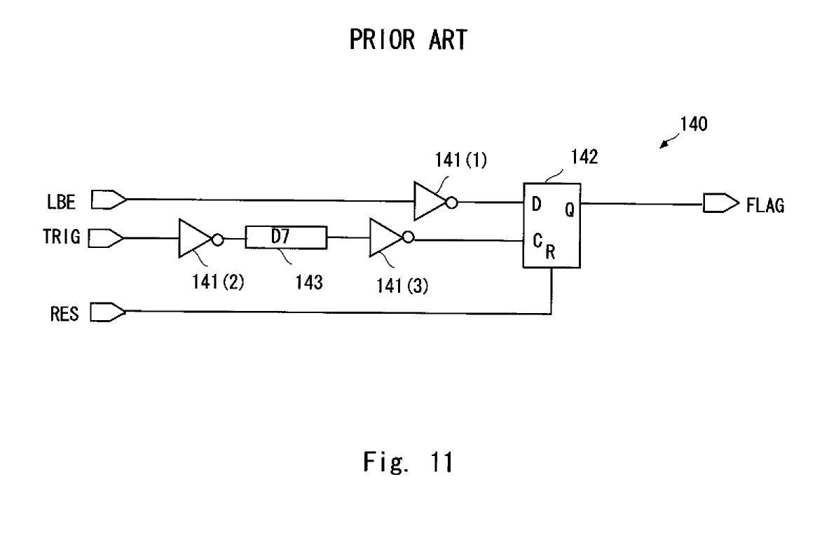

The control circuit 5, the display read signal generation circuit 6, and the judgment flag signal generation circuit 7 correspond to a control unit 110, a display read signal generation circuit 130, and a judgment flag signal generation circuit 140 according to the related art shown in FIG. 8, respectively. Further, the second output signal 17 corresponds to a display read signal. The structures and the operations are similar to those of the internal synchronous control circuit disclosed in Japanese Unexamined Patent Application Publication No. 2003-288202 according to the related art, and thus description will be omitted. The control circuit 5, the display read signal generation circuit 6, and the judgment flag signal generation circuit 7 of the display apparatus according to the first exemplary embodiment are similar to the control unit 110, the display read signal generation circuit 130, and the judgment flag signal generation circuit 140 according to the related art. It is not limited to the specific configuration of the circuits shown in FIGS. 9, 10, and 11.

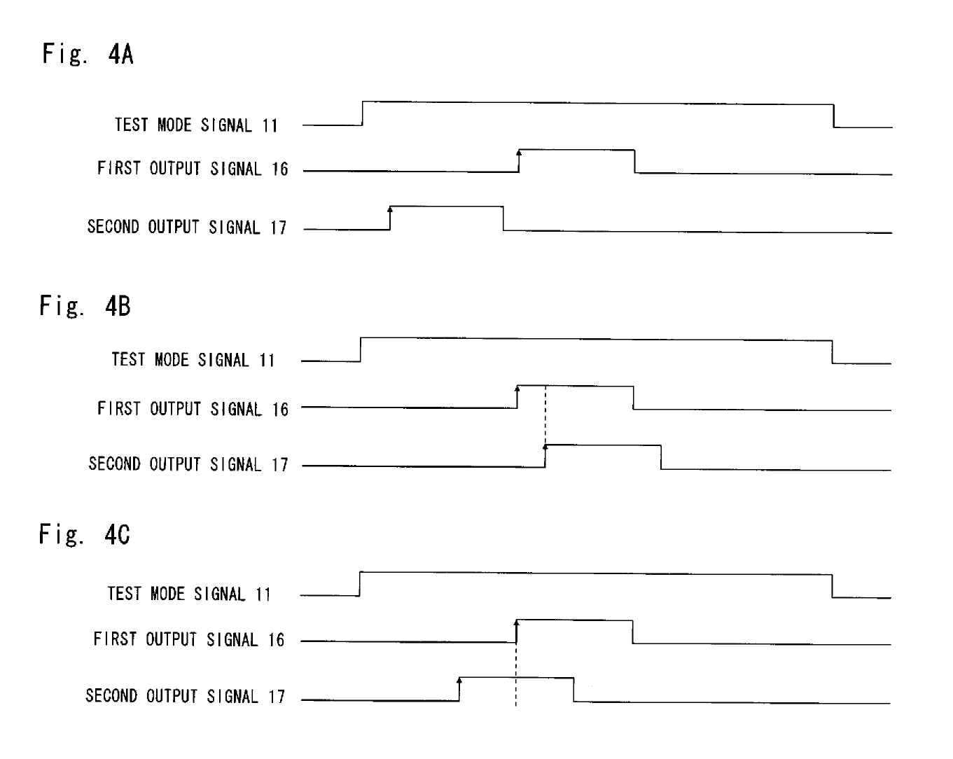

Now, the operation of the competing test circuit of the display apparatus according to the first exemplary embodiment will be described. FIG. 4 is a timing chart showing states of the first output signal 16 and the second output signal 17 generated by the delay generation circuit 2 that constitutes the competing test circuit of the display apparatus according to the first exemplary embodiment.

As shown in FIG. 4, timings of the two signals input to the input order judgment circuit 3 include three states of a state in which active periods of the first output signal 16 and the second output signal 17 are not overlapped (FIG. 4A, hereinafter referred to as first state), a state in which the second output signal 17 becomes active when the first output signal 16 is active (FIG. 4B, hereinafter referred to as second state), and a state in which the first output signal 16 becomes active when the second output signal 17 is active (FIG. 4C, hereinafter referred to as third state).

At this time, it is required to check that the display apparatus is operated without problems in the second state or the third state. It is also required to check the operation when the two signals of the first output signal 16 and the second output signal 17 become active substantially at the same timing. In the competing test circuit of the display apparatus according to the first exemplary embodiment, the input order of the two signals of the first output signal 16 and the second output signal 17 is judged using the input order judgment circuit 3, and the timing at which the first output signal 16 and the second output signal 17 become active is controlled using the delay generation circuit 2 based on the judgment result.

There are a normal mode and a test mode in the competing test circuit 1. The normal mode and the test mode can be set according to the value of the test mode signal 11. When the test mode signal 11 is “0”, the mode is set to the normal mode; when the test mode signal 11 is “1”, the mode is set to the test mode. In the following description, the operation in the test mode will be described with reference to FIGS. 1, 2, and 5.

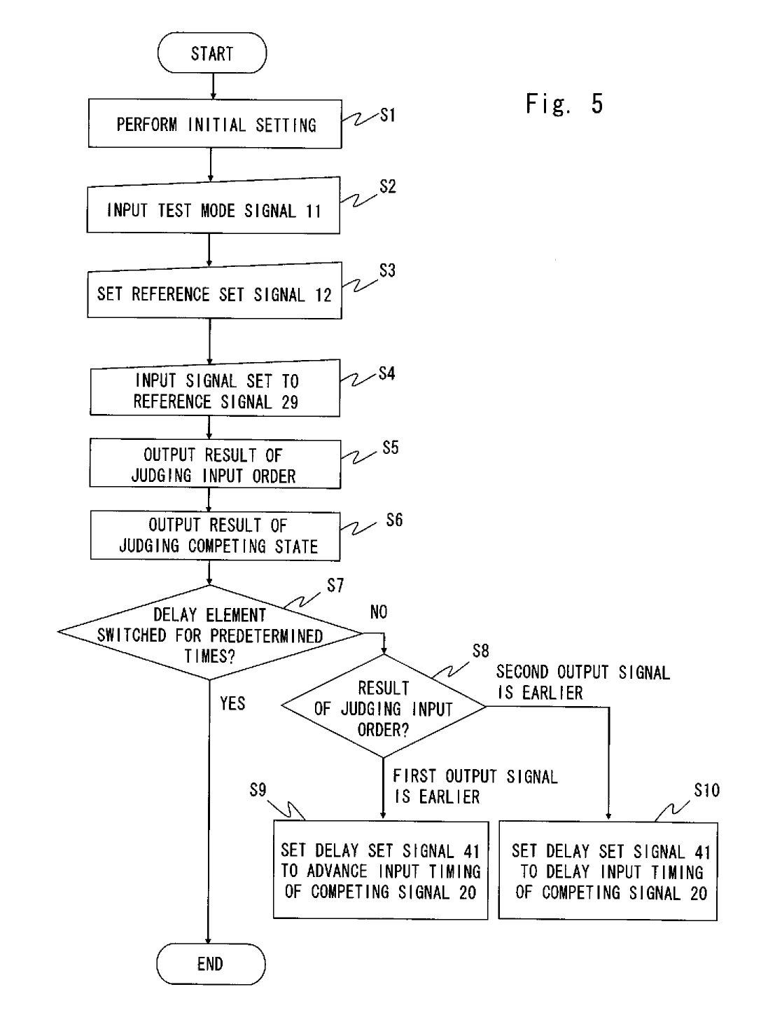

FIG. 5 is a flow chart showing processing of the competing test circuit shown in FIG. 1. First, an initial value is set in each internal circuit of the competing test circuit 1 (S1). Next, the test mode signal 11 is set to “1”, and the competing test circuit 1 is set to the test mode (S2). Then, the reference set signal 12 is set to “0” or “1”, so as to determine whether to output the reference signal 29 of the delay generation circuit 2 shown in FIG. 2 from the first output signal 16 and output the competing signal 20 from the second output signal 17, or to output the competing signal 20 from the first output signal 16 and output the reference signal 29 from the second output signal 17 (S3). In summary, when the reference set signal 12 is set to “1”, the reference signal 29 is output from the first output signal 16, and the competing signal 20 is output from the second output signal 17. On the other hand, when the reference set signal 12 is set to “0”, the competing signal 20 is output from the first output signal 16, and the reference signal 29 is output from the second output signal 17. In the first exemplary embodiment, the reference set signal 12 is set to “1”, as an example.

As the test mode signal 11 is set to “1”, the two-input selector 24 outputs an output (fixed value) of any delay element that can be selected from the delay element group 27 as the reference signal 29 (S4). Then, it is judged in the input order judgment circuit 3 which of the first output signal 16 (in this case, reference signal 29) and the second output signal 17 (in this case, competing signal 20) is input at an earlier timing, and the input order judgment signal 35 which is the judgment result is output (S5). Further, it is judged whether the two signals of the first output signal 16 and the second output signal 17 are competing, and the competing state judgment signal 36 which is the judgment result is output (S6).

Next, it is judged in the delay time set circuit 4 whether the delay element has been switched for a predetermined number of times (S7). The number of times of switching of the delay element can be externally set, for example, as a set value of the competing test circuit. The processing goes to S8 in an initial stage.

Next, the input order judgment signal 35 is input to the delay time set circuit 4 to judge the input order of the first output signal 16 and the second output signal 17 (S8). When it is judged that the first output signal 16 is input at an earlier timing in S8, the delay set signal 41 is output so as to advance the input timing of the competing signal 20 (to advance the output timing of the second output signal 17) (S9). The delay generation circuit 2 generates the competing signal 20 which is raised at the timing based on the delay set signal 41. By advancing the output timing of the second output signal 17 (competing signal 20), the timing of rising of the second output signal 17 shown in FIG. 4B can be made close to the timing of rising of the first output signal 16.

Upon judgment in S8 that the second output signal 17 is input at the earlier timing, the delay set signal 41 is output so as to delay the input timing of the competing signal 20 (to delay the output timing of the second output signal 17) (S10). The delay generation circuit 2 generates the competing signal 20 which is raised at the timing based on the delay set signal 41. By delaying the output timing of the second output signal 17 (competing signal 20) in this way, the timing of rising of the second output signal 17 shown in FIG. 4C can be made close to the timing of rising of the first output signal 16.

The operations of S4 to S10 are repeated until the switching of the delay element is performed for a predetermined number of times.

At this time, the first output signal 16 which is output from the two-input selector 25 shown in FIG. 2 is input to the control circuit 5 as the WE bar signal 18 and the RE bar signal 19 based on the write/read judgment signal 15. Further, the second output signal 17 is also input to the control circuit 5 as the display read signal. At the timing at which the first output signal 16 and the second output signal 17 are generated in the test mode, the operation test of the control circuit 5, the display read signal generation circuit 6, and the judgment flag signal generation circuit 7 shown in FIG. 1 can be performed. Note that the operations of the control circuit 5, the display read signal generation circuit 6, and the judgment flag signal generation circuit 7 are similar to those described in the related art.

In the competing test circuit of the display apparatus according to the first exemplary embodiment, the input order of the two signals of the first output signal 16 (corresponding to the WE bar signal 18 or the RE bar signal 19) and the second output signal 17 (corresponding to the display read signal) is judged using the input order judgment circuit 3, and the timings of the first output signal 16 and the second output signal 17 are controlled using the delay generation circuit 2 based on the judgment result. This makes it possible to achieve the above-described second and third states, or a state in which the two signals of the first output signal 16 and the second output signal 17 are made active substantially at the same timings, and the internal synchronous control circuit of the display apparatus can be tested with this state. Hence, it is possible to test the internal synchronous control circuit while checking the timings of the first output signal 16 and the second output signal 17, thereby enhancing fault coverage of the internal synchronous control circuit.

When the internal synchronous control circuit is tested according to the related art, the test is performed while stochastically predicting the competing state, which produces variations in fault coverage and degrades the reliability of the test. However, in the competing test circuit according to the first exemplary embodiment, the competing state can be checked, thereby enhancing the fault coverage. Further, the competing test circuit according to the first exemplary embodiment includes the variable delay circuit. Thus, the timing of rising of the first output signal 16 and that of the second output signal 17 can be controlled based on the competing state which is measured and tests in various input timings can be executed.

In the normal mode, the write/read signal 13 is output as the WE bar signal 18 and the RE bar signal 19 through the two-output selector 28 in the delay generation circuit 2. The display read signal 14 is output as the second output signal 17 through the delay generation circuit 2. Thus, in the normal mode, as disclosed in Japanese Unexamined Patent Application Publication No. 2003-288202, the write/read signal 13 is input to the control circuit 5 as the WE bar signal 18 or the RE bar signal 19 according to the write/read judgment signal 15, and the display read signal 14 is also input to the control circuit 5.

Next, the operation test method of the display apparatus according to the first exemplary embodiment will be described. An operation test method of a display apparatus including an internal synchronous control circuit controlling transfer of display data between a CPU and a display panel according to the first exemplary embodiment includes the following steps: generating a reference signal and a competing signal; judging an input order of the reference signal and the competing signal; generating the delay set signal based on judgment result of the input order; generating the competing signal based on the delay set signal; and executing an operation test of the internal synchronous control circuit using the reference signal and the competing signal.

In the operation test method of the display apparatus according to the first exemplary embodiment, the operation test of the internal synchronous control circuit is executed using the reference signal and the competing signal that are competing each other. The fault coverage is thus enhanced.

In the operation test method of the display apparatus according to the first exemplary embodiment, when the timing of rising of the reference signal is earlier than the timing of rising of the competing signal, the timing of rising of the competing signal can be advanced.

On the other hand, in the operation test method of the display apparatus according to the first exemplary embodiment, when the timing of rising of the reference signal is delayed from the timing of rising of the competing signal, the timing of rising of the competing signal can be delayed.

### Second Exemplary Embodiment

Now, a competing test circuit of a display apparatus according to a second exemplary embodiment of the present invention will be described. The processing in the competing test circuit according to the second exemplary embodiment is different from that of the first exemplary embodiment. The other structures are similar to those of the competing test circuit according to the first exemplary embodiment, and thus description will be omitted.

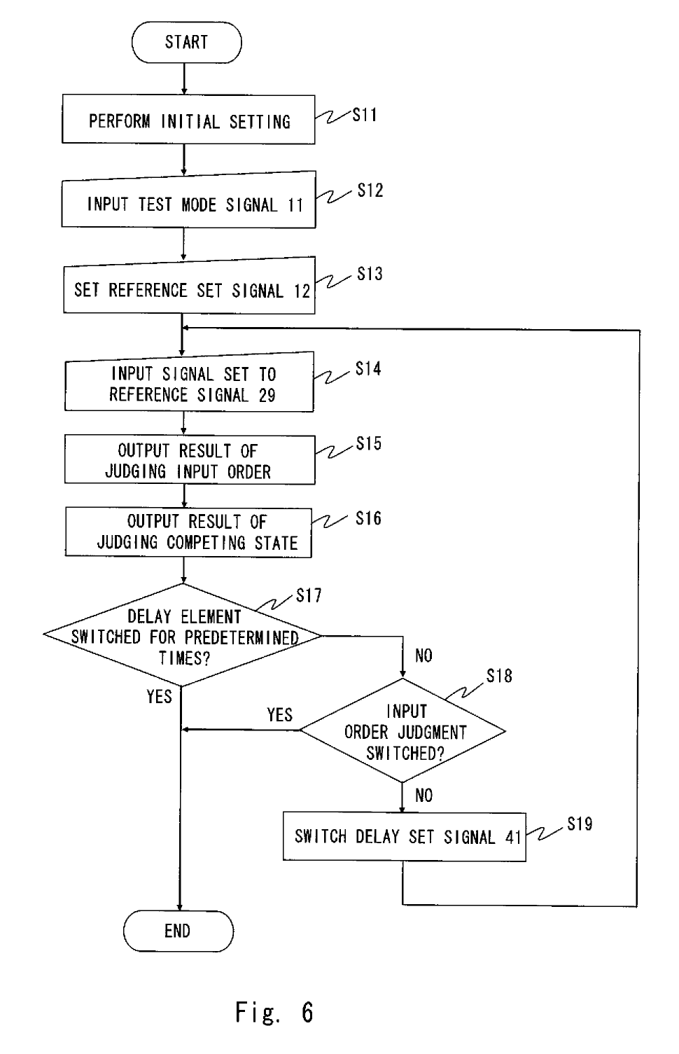

FIG. 6 is a flow chart showing the processing of the competing test circuit according to the second exemplary embodiment. In the second exemplary embodiment, the set value of the delay set signal 41 that can be set is sequentially reduced from a maximum value, or the set value of the delay set signal 41 that can be set is sequentially increased from a minimum value. In short, the delay set signal is generated so as to gradually advance the timing of rising of the competing signal from the latest timing of rising. Otherwise, the delay set signal is generated so as to gradually delay the timing of rising of the competing signal from the earliest timing of rising. The operation test of the internal synchronous control circuit is terminated at a timing at which the input order of the reference signal and the competing signal is switched. The other operations, S11 to S17, are similar to those of S1 to S7 of the first exemplary embodiment.

In S18, it is judged whether the input order judgment signal 35 which is the judgment result of S15 is equal to the result of the previous judgment. When it is judged in S18 that the current input order judgment signal 35 is equal to the previous input order judgment signal 35, the value of the delay set signal 41 is changed (S19). Then, the operations of S14 to S19 are repeated until judgment in S17 that the switching of the delay element has been performed for a predetermined number of times or until when the current input order judgment signal 35 becomes different from the previous input order judgment signal 35.

Taking FIG. 4B as an example, when the timing of rising of the second output signal 17 gradually approaches the timing of rising of the first output signal 16, and the timing of rising of the first output signal 16 and the timing of rising of the second output signal 17 are reversed, the current input order judgment signal 35 is judged to be different from the previous input order judgment signal 35.

Further, when switching of the delay element is performed for a number of times externally set in advance, it is judged in S17 that switching of the delay element is performed for a predetermined number of times, for example.

Although the method of setting the delay set signal 41 in the delay time set circuit 4 in the competing test circuit according to the second exemplary embodiment is different from that in the first exemplary embodiment, the similar result as in the first exemplary embodiment can be obtained.

The first and second exemplary embodiments can be combined as desirable by one of ordinary skill in the art.

While the invention has been described in terms of several exemplary embodiments, those skilled in the art will recognize that the invention can be practiced with various modifications within the spirit and scope of the appended claims and the invention is not limited to the examples described above.

Further, the scope of the claims is not limited by the exemplary embodiments described above.

Furthermore, it is noted that, Applicant's intent is to encompass equivalents of all claim elements, even if amended later during prosecution.

What is claimed is:

1. A display apparatus comprising:
a delay generation circuit that generates a reference signal and a competing signal, the competing signal being generated based on a delay set signal;
an input order judgment circuit that judges an input order of the reference signal and the competing signal;
a delay set circuit that generates the delay set signal based on a judgment result in the input order judgment circuit; and
an internal synchronous control circuit that controls transfer of display data between a CPU and a display panel, wherein
an operation test of the internal synchronous control circuit is performed using the reference signal and the competing signal.

2. The display apparatus according to claim 1, wherein, when a timing of rising of the reference signal is earlier than a timing of rising of the competing signal, the delay set circuit generates the delay set signal to advance the timing of rising of the competing signal.

3. The display apparatus according to claim 1, wherein, when a timing of rising of the reference signal is later than a timing of rising of the competing signal, the delay set circuit generates the delay set signal to delay the timing of rising of the competing signal.

4. The display apparatus according to claim 1, wherein the delay set circuit generates the delay set signal so as to gradually advance the timing of rising of the competing signal from the latest timing of rising.

5. The display apparatus according to claim 1, wherein the delay set circuit generates the delay set signal so as to gradually delay the timing of rising of the competing signal from the earliest timing of rising.

6. The display apparatus according to claim 4, wherein the operation test of the internal synchronous control circuit is terminated at a timing at which the input order of the reference signal and the competing signal is switched.

7. The display apparatus according to claim 5, wherein the operation test of the internal synchronous control circuit is terminated at a timing at which the input order of the reference signal and the competing signal is switched.

8. The display apparatus according to claim 1, wherein the delay generation circuit includes a delay element group and a multi-input selector, and the multi-input selector selects any one of outputs of the delay element group based on the delay set signal to generate the competing signal.

9. The display apparatus according to claim 1, wherein the reference signal is corresponding to a control signal that controls transfer of the display data between the CPU and a memory, and the competing signal is corresponding to a control signal that controls transfer of the display data from the memory to the display panel.

10. The display apparatus according to claim 1, wherein the reference signal is corresponding to a control signal that controls transfer of the display data from a memory to the display panel, and the competing signal is corresponding to a control signal that controls transfer of the display data between the CPU and the memory.

11. An operation test method of a display apparatus including an internal synchronous control circuit, the circuit controlling transfer of display data between a CPU and a display panel, the operation test method comprising:
generating a reference signal and a competing signal;
judging an input order of the reference signal and the competing signal;
generating the delay set signal based on judgment result of the input order;
generating the competing signal based on the delay set signal; and
executing an operation test of the internal synchronous control circuit using the reference signal and the competing signal.

12. The operation test method of the display apparatus according to claim 9, wherein, when a timing of rising of the reference signal is earlier than a timing of rising of the competing signal, the timing of rising of the competing signal is advanced.

13. The operation test method of the display apparatus according to claim 9, wherein, when a timing of rising of the reference signal is later than a timing of rising of the competing signal, the timing of rising of the competing signal is delayed.

14. The operation test method of the display apparatus according to claim 9, wherein the delay set signal is generated so as to gradually advance the timing of rising of the competing signal from the latest timing of rising.

15. The operation test method of the display apparatus according to claim 9, wherein the delay set signal is generated so as to gradually delay the timing of rising of the competing signal from the earliest timing of rising.

16. The operation test method of the display apparatus according to claim 12, wherein the operation test of the internal synchronous control circuit is terminated at a timing at which the input order of the reference signal and the competing signal is switched.

17. The operation test method of the display apparatus according to claim 13, wherein the operation test of the internal synchronous control circuit is terminated at a timing at which the input order of the reference signal and the competing signal is switched.
